(19) United States
(12) Patent Application Publication
(10) Pub. No.: US 2018/0032878 A1
(43) Pub. Date: Feb. 1, 2018

(54) Dynamic Goal Lattice Creation and Display Apparatus

(71) Applicants: Kenneth J. Hintz, Fairfax Station, VA (US); Andrew S. Hintz, Avon, IN (US)

(72) Inventors: Kenneth J. Hintz, Fairfax Station, VA (US); Andrew S. Hintz, Avon, IN (US)

(21) Appl. No.: 15/662,476

(22) Filed: Jul. 28, 2017

Related U.S. Application Data
(60) Provisional application No. 62/368,196, filed on Jul. 29, 2016.

(51) Int. Cl. G06N 5/02; G05B 19/042

(52) U.S. Cl. CPC G06N 5/022; G05B 19/0426; G05B 2219/23405

(57) ABSTRACT

The present invention relates to methods and apparatus for entering data for a goal lattice, displaying the graph of goals and edges, and extracting sublattices of goals and edges for detailed data entry, display, and analysis. More particularly, the present invention relates to methods, systems, and apparatus for visualizing goals and their relationship in a multidimensional visualization. In preferred embodiments, goal lattices are displayed such that direct human interaction through a graphical user interface and data entry devices allow for the addition, modification, and extraction of goal lattices and their visualization.

### CROSS-REFERENCE TO RELATED APPLICATIONS

This application claims the benefit of U.S. Provisional Application No. 62/368,196, filed Jul. 29, 2016, which is hereby incorporated by reference in its entirety.

### BACKGROUND OF THE INVENTION

In order to manage sensors in a heterogeneous, multi-sensor environment, it is necessary to associate each information request or sensory input with a value representing the significance of that information request or sensory input. Conventionally, the amount of information collected using sensors is maximized in order to decrease the uncertainty between a mathematical model of the world and the world itself. However, while information is useful in establishing a reliable mathematical model of the world and is therefore a necessary condition for sensor management, the collection of thorough sensory information is not a sufficient condition for a comprehensive approach to sensor management. Rather, without exercising some form of discretion with regard to information sought and/or collected, computations performed based on the collected information may produce skewed results and may be unnecessarily complex and resource consuming.

The same principles and problems apply to conventional decision-making models. Conventional decision making models include abstract goals and discrete action tasks, but do not provide a mechanism for quantitatively relating the two. For that reason, it is difficult to determine which of several tasks has the highest relative contribution to the accomplishment of one or more system goals, and thus, which task is most critical to the satisfaction of the system goals.

### BRIEF DESCRIPTION OF THE SEVERAL VIEWS OF THE DRAWINGS

The present invention will become more fully understood from the detailed description given herein below and the accompanying drawings which are given by way of illustration only, and thus are not limitative of the present invention, and wherein:

FIGS. 1A and 1B illustrate examples of uniformly and non-uniformly apportioned goal lattice structures in accordance with the present invention;

FIG. 1C illustrates an example of a computer housing a computer readable medium storing a computer program that comprises code segments capable of performing processes in accordance with the concepts of the present invention as well as the linkage between the goal lattice apparatus and the control system and system under control;

FIG. 2 illustrates an exemplary flowchart of steps performed by a method used to display and modify the elements of a goal lattice;

FIG. 3 illustrates and example of a particular goal lattice structure used to describe one implementation of the present invention;

FIG. 4 illustrates the relationship among the various goals of a goal lattice and the levels that comprise them;

FIG. 5. illustrates how two collaborating agents can have both their own local goals and contribute to shared goals for which they are both responsible;

FIG. 6. is an exemplary display showing the projection of a goal lattice onto two dimensions. The dynamic behavior in manipulating the goal lattice is not shown.

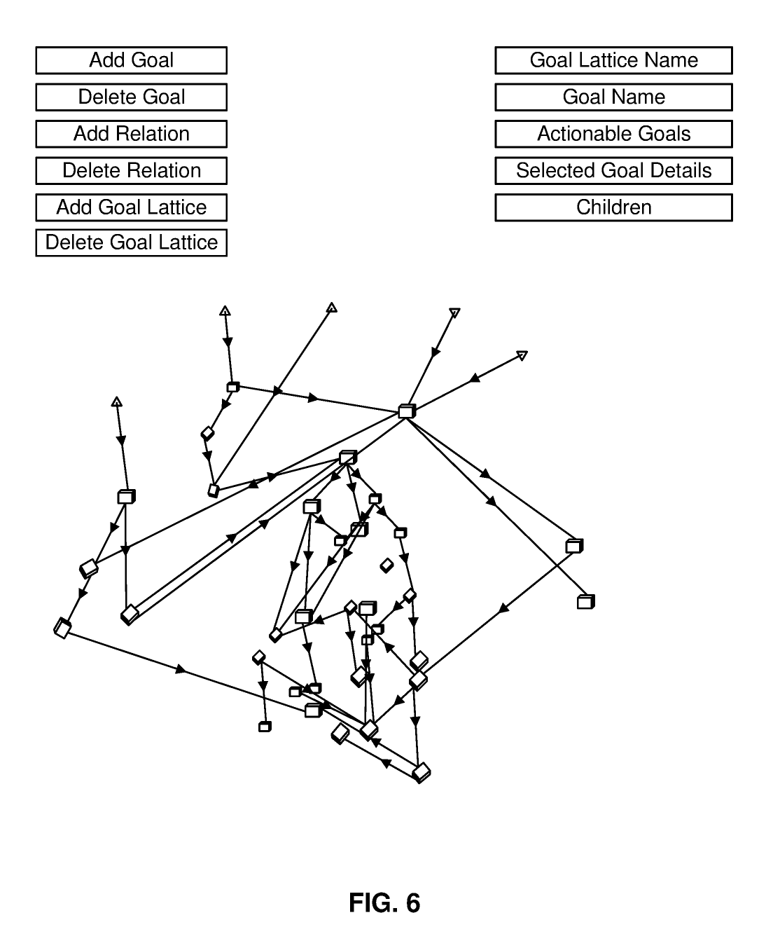

### DETAILED DESCRIPTION OF EMBODIMENTS

The present invention relates to methods and apparatus of measuring a relative utility for each of a plurality of goals which comprise a system objective and moreover, utilizing this relative utility as an element of an automatic control system. More particularly, the present invention relates to methods, systems, and apparatus for quantifying the relative contribution of specific goals to a set of broader goals, and for enabling decision making, and resource allocation, with regard to the performance of those goals based on the quantified relative contribution. The present invention also relates to methods and apparatus for the creation, modification, and display of goal lattices and outputting these modified goal lattices to an automatic control system. These goal lattices can be either static or dynamic. Likewise, the display of these goal lattices can be static or dynamic. The dynamic display of goal lattices which are changing over time or in response to external stimuli have the capability of more readily transferring knowledge of system behavior to a human operator. In preferred embodiments, a goal lattice is created based on an ordering relation and relative values are apportioned to the goals using their position in the goal lattice as including, included, or unrelated. Preferred embodiments also include visualization methods for the real-time manipulation of goal lattices and graphical user interface methods for manipulating the goal lattice and selecting various components for manipulation and modification. Visualization devices may be non-visual such as pixelated touch-pads implementing protruding pins or acoustic waves that can be sensed by human touch. Preferred embodiments also include dynamic representations of the changing goal lattice in order to transfer information about the dynamics of the relative values which are used to control a system through a method of automatic controls.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, some of the above explanation has focused on the example of an embodiment where the dynamic goal lattice creation and display apparatus may be employed as a means for enabling the collaboration of agents. However, one skilled in the art will recognize that embodiments of the invention could be employed in other areas such as, but not limited to: public utilities, mass transit systems, budgets, cost/benefit analysis, sensor management, mission management, combinations thereof, and/or the like.

In addition, it should be understood that any figures that highlight any functionality and/or advantages, are presented for example purposes only. The disclosed architecture is sufficiently flexible and configurable, such that it may be utilized in ways other than those shown. For example, the steps listed in any flowchart may be re-ordered or only optionally used in some embodiments. Elements in the figures with the dashed lines may be indicative of optional elements that may be employed, in various combinations to create alternative embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

The present invention relates to methods, systems, and apparatus for allocating resources to accomplish a system objective, comprising one or more of the following steps in any effective order and the modification and display of the resulting goal lattice:
identifying a plurality of goals for accomplishing a system objective;
defining an ordering relation on said plurality of goals;
applying said ordering relation to said plurality of goals to create a goal lattice;
assigning a value to each goal, e.g., with an arbitrary assignment of value to the topmost goal, such as a value of 1.0, wherein the value of each including goal can be, e.g., apportioned among its included goals and the value of each included goal is assigned by summing the value apportioned to it by its including goals; and/or allocating resources to each goal using said assigned values.

By the phrase allocating resources it is meant any activity, mental or physical, in which a resource is distributed. A resource can therefore be a physical action, a performance of task(s), financial expenditure(s), decision(s), staff, network time, pointing a radar or other electromagnetic energy sensor at a particular target in order to measure its position or measure its associated feature vector, electrical power to subcomponents on an integrated circuit, power distribution in a microgrid utility network, network connections of various speeds and quality of service, employees capable of performing different tasks, trucks used for delivering goods, telephone communications paths (landline, microwave, satellite), environmental sensors on a robot, computational power, such as in the form of allocating a number of gates on an integrated circuit to a particular task, either a priori or in real-time, reconfiguration in a Field Programmable Gate Array (FPGA), etc.

Resources can be allocated for the purpose of accomplishing a system objective. A system objective is generally a top-level purpose. For example, in a business, a system objective can be to achieve a dominant share in the market, to develop new products, or to achieve a certain level of profitability. Along these lines, the method can be useful for allocating resources, such as money and personnel, in order to achieve the goal of obtaining a dominant share in the market.

To perform the method, a plurality of goals for accomplishing the system objective can be identified. By the term goal, it is meant any task, activity, end-result, etc., which is to be considered in order to accomplish the system objective. In the business example of achieving a dominant share in the market, goals can be, e.g., to open a new store, to purchase the land for the new store, to hire a contractor to build the store, to get the necessary building permits, to establish an internet connection to the store, to analyze the market, to hire a cleaning company, to develop new products, to conduct applied research, to conduct basic research, to produce a product for sale, to manufacture a product, to advertise a product, to create a sales force, to create a support staff, to create a scientific staff, to conduct market research, etc. All such activities can be characterized as goals and the act of selecting which goals to consider to achieve the system goal can be characterized as “identifying a plurality of goals.” Goals can identified by a human operator, by automatically using artificial intelligence (AI) based algorithms, etc. In the microgrid power management example, goals can be, e.g., to minimize cost, to reduce dependence on the electrical grid, to increase comfort, to utilize stored energy, or to put locally generated power back on the grid.

After goals are identified, in a preferred embodiment of the invention, an ordering relation is defined. The phrase ordering relation means any property that can be said to hold (or not to hold) for two objects in a specified order such that x<y, y<x, or x and y are unrelated (where the left carat, <, means whatever is on the left side of the caret is included in whatever is on the right side of the caret). If x<y and y<x, then x=y. Also, if x<y, and y<z, then x<z. The combination of an ordering relation and a set of objects (in this case, goals) yields a partially ordered set (POSET).

An ordering relation is used as a means of classifying the multiplicity of goals as (a) included goals (i.e., goals which are included in, are a part of, or contribute to the accomplishment of high-level goals), (b) including goals (higher-level goals which encompass included goals, and (c) unrelated goals.

An including goal is one which is comprised of included goals, i.e., included goals are included in an including goal. In the business example above, the goal of developing new products is an including goal which has the following included goals: conducting basic research, conducting applied research, creating a scientific staff, and conducting market research. Goals such as creating a sales force and manufacturing a product may be unrelated to the goal of developing new products and therefore can be characterized as unrelated goals.

The ordering relation is used to create a goal lattice. By term goal lattice, it is meant, a representation of the relationship among all the goals as imposed by the ordering relation, preferably having a greatest lowest bound (g.l.b.) and a least upper bound (l.u.b.). The representation can be graphical (e.g., a 2-D Hasse diagram, or a 3-D representation, or a dynamic, multidimensional graphical representation), a matrix, or any suitable form. A sublattice is a portion of a lattice. A goal lattice can be created by any conventional or state-of-the-art method. See, e.g., James and James Mathematics Dictionary [lattice: A partially ordered set in which any two elements have a greatest lower bound (g.l.b.) and a least upper bound (l.u.b.), the g.l.b. of a and b being an element c such that c<=[less than or equal to, included in or equal to] a, c<=b, and there is no d for which c<d<=a and d<=b, and the l.u.b. being defined analogously] and Naive Set Theory by Paul R. Halmos, 1960.

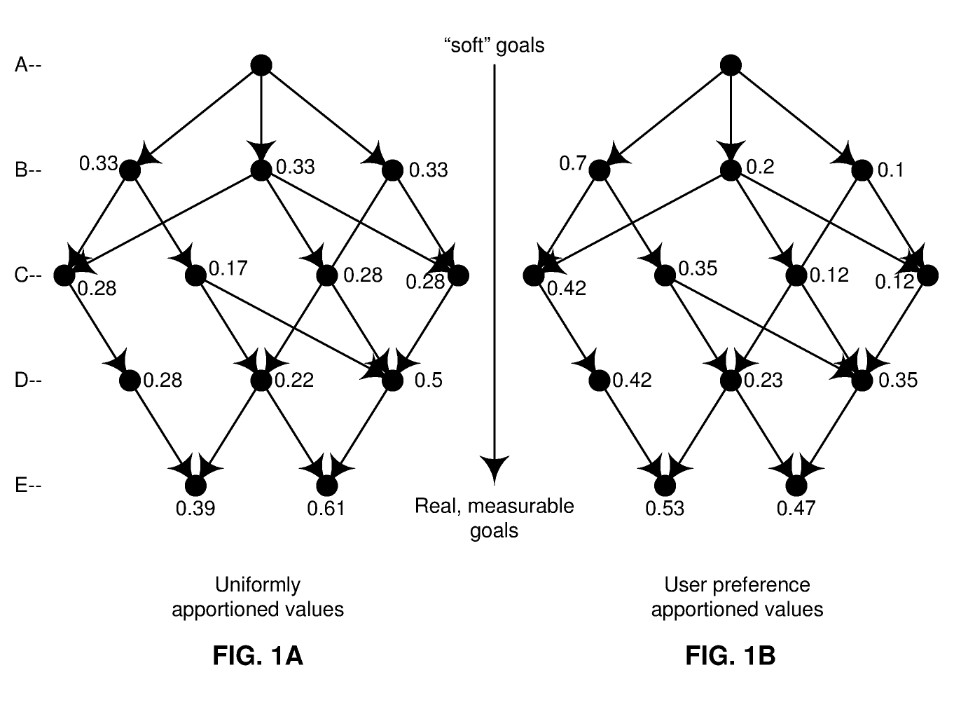

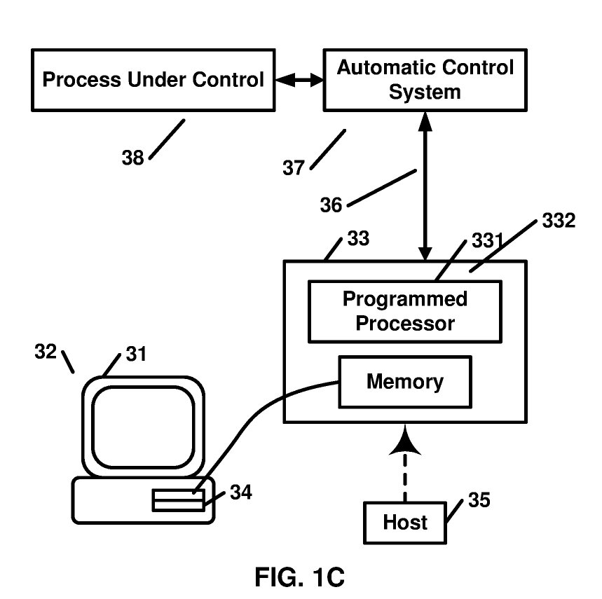

Goals which are unrelated by the ordering relation, and are all included in one or more including goals, can be characterized as being on a level. See, e.g., FIG. 1A, levels A, B, C, D, and E. Mathematically, these unrelated goals have a least upper bound (l.u.b.) as described in the definition of goal lattice above.

After a goal lattice has been created, a further step of the invention preferably comprises assigning a value to each of the goals in the goal lattice. The goal lattice and the assigned values is referred to simply as a goal lattice. Values of the goal lattice can be assigned by any effective method which apportions the value of including goals among the corresponding included goal. Apportionment can be arbitrary, uniform, calculated using an algorithm or function, subjective by a human operator evaluating the relative utility of each goal, etc. For instance, with reference to FIG. 1A. a topmost goal, i.e, the system objective, can be assigned an arbitrary value of 1. This value can be apportioned uniformly among the included goals as shown in FIG. 1A, it can be apportioned to a user-preference as shown in FIG. 1B, it can be apportioned automatically by an algorithm, or function, or any other suitable means of apportioning values among goals.

In accordance with a preferred embodiment, the values are assigned such that the value of each including goal is apportioned among its included goals and the value of each included goal is assigned by summing the value apportioned to it by its including goals. Such step for uniform apportionment is illustrated in FIG. 1.

An assignment of value to a goal does not have to be static but can also vary dynamically. Values can be also determined continuously, intermittently, periodically, etc, by any mathematical function which automatically computes and updates their values based on changes in the environment.

Once values are assigned to goals in the goal lattice, resources can be allocated to each goal using the assigned values. Allocation can be temporal allocation where a value tells the user which goal to perform first. Allocation can also be proportional where a value tells the user how much of the resource to allocate toward a specific goal. For example, with reference to FIG. 1, where goals are mutually exclusive, values can be used to determine which goal to perform first, e.g., a higher value can mean that the goal should be performed before, or prior to, a goal with a lower value on a particular level of goals. If a goal is not mutually exclusive, the values can be used to determine how much expenditure is allocated to each, e.g., a higher value gets a higher expenditure of money.

As mentioned, methods and systems of the present invention, can be used for a variety of purposes, including, e.g., business applications, military system design and control applications, community planning research and development, employee compensation, etc., in virtually any environment in which resource allocation is to be accomplished and in which a user can apportion values among the various included goals.

For example, a method of the present invention can be used to determine which of several networks to use, such as a T1 line, a fiber-optic, and a digital subscriber line (DSL). A system objective in such a case can be to achieve customer satisfaction. Identified goals can include, e.g., rate of data input for each line, rate of data output for each line, costs of each line, speed of response, quality of service (QOS), etc.

A goal lattice can be stationary or non-stationary. For instance, once an ordering relation among a plurality of goals is created, an assigning step can be performed at different times to adjust for changing user-preferences, or other measures of goal utility.

In an embodiment of the invention, the method is applied to sensor management. To perform sensor management comprehensively, values must be assigned to designate the significance of each information request or sensor output since not all information requests and sensor outputs can be satisfied in a constrained or stressing environment, and some method must be available to decide which requests to satisfy given the existence of resource limitations and environment stresses. To that end, the present invention involves a system and method for assigning values to information requests or sensory outputs, which values represent the relative contribution of those information requests or sensor outputs to the accomplishment of one or more of several system goals.

FIGS. 1A and 1B illustrate examples of uniformly and non-uniformly apportioned goal lattice structures in accordance with the present invention, demonstrating a relationship among goals that are related or unrelated in accordance with an ordering relation. Specifically, as shown in FIGS. 1A and 1B, two goal lattice structures are shown, each having several layers of nodes (e.g., A-E), each node representing a goal. The level of abstraction for each node within the goal lattice structure is such that the top-most nodes represents system goals having a highest order of abstraction (e.g., conceptual, tactical goals or “soft” goals) while the bottom-most nodes represent system goals and tasks having the lowest order of abstraction (e.g., real and measurable goals or “hard” goals). In other words, since the bottom-most goals have the lowest order of abstraction, they generally represent specific tasks that may be performed to accomplish the higher order system goals. In these goal lattice structures, goals on the same level generally have the same level of abstraction.

FIG. 1C illustrates an example of a computer having a computer readable medium that stores a computer program comprising code segments capable of performing processes in accordance with the concepts of the present invention. As shown in FIG. 1C, the computer includes at least a video display device (VDD) 31 and a main unit 32 including a main processing board 33 and storage device 34. Main processing board 33 includes programmed processor 331 and computer-readable memory 332. Computer-readable memory 332 can include a random access memory (RAM), a read only memory (ROM), or any volatile or non-volatile memory device. Storage medium 34 is another computer-readable memory device which can include a fixed hard disk drive and/or a removable storage medium for a non-fixed disk drive such as a floppy disk or a digital versatile disk (DVD). The storage medium 34 may be a place where the mathematical representations of goal lattices are stored and retrieved from. A program is stored on one of the computer-readable memory devices which causes the processor 331 to implement a method according to the invention. The modified goal lattice of 36 is transferred to the automatic control system 37 which subsequently sends control signals to the system under control 38.

Alternatively, a host device 35 such as an external apparatus may be used to download a program which causes the processor 331 to implement the method according to the invention, in which case, the computer-readable medium in which the program is embodied takes the form of a propagated signal. The processor 331 may be a graphics processing unit (GPU) with specialized instructions to facilitate the manipulation of images to display.

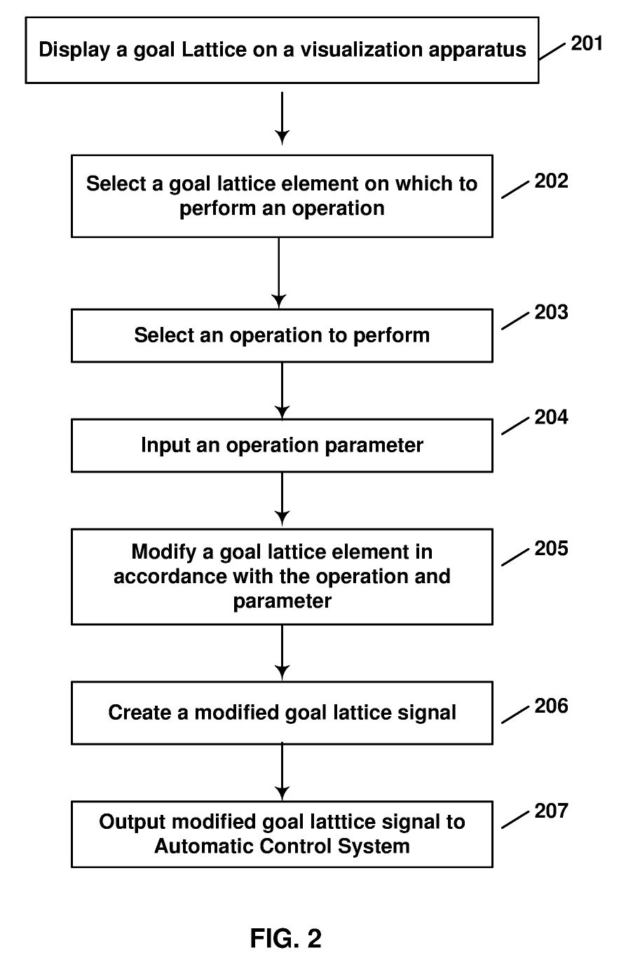

FIG. 2 illustrates an exemplary flowchart of steps performed by a method used to modify the goal lattice structure and values of a selected goal lattice. The selected goal lattice is displayed on a visualization apparatus in step 201 of FIG. 2. Input devices which could include a keyboard, mouse, touchpad, or kinematic input device, are used to select the element on which to perform an operation in step 202. In Step 203 the operation to perform on the goal lattice is selected or manually input on a keyboard. In Step 204, the parameters to apply to the selected operation are specified. The computational device then operates on the existing goal lattice to modify it in accordance with the selected operation and its associated parameters to produce a modified goal lattice in Step 206. Finally, Step 207 outputs the modified goal lattice signal to the automatic control system.

The theory of orderings or ordering relations is applied by the present invention to relate system goals for a sensory system or decision making system and the tasks used to accomplish those systems goals. In general, this theory dictates that a partially ordered set is comprised of two components, a set of elements and an ordering relation defined on that set.

X={S,≦}

If the ordering relation relates every element to every other element, then the set and ordering relation form a totally ordered set or a chain. For example, if the set includes all integers and the ordering relation is the simple arithmetic “less than,” then we have a totally ordered set because every integer is “less than” some other integer. Conversely, if the set and ordering relation do not relate all elements but each pair of elements have both a greatest lower bound (g.l.b.) and a least upper bound (l.u.b.), then the set and ordering relation form a partially ordered set (POSET), also called a goal lattice. For a POSET, the inclusion relationship (e.g., ≦) must meet the three requirements of reflexivity, asymmetry and transitivity. An example of an inclusion relation is the set:

S={A,B,C},

where the ordering relation is defined as “is a subset of.” Clearly {A, B} is a subset of {A, B, C}, but {A,C} is not a subset of {A,B}.

The ordering relation may be defined as “(this goal) is necessary to achieve (this other goal)”. By applying this ordering relation to the set of goals, a goal lattice structure is achieved, such as that shown in FIG. 1A or that shown in FIG. 1B.

A quantitative measure of relative utility is determined for each goal based on the relative contribution of that system goal to the accomplishment of higher order system goals. This process involves two steps, goal value apportionment and goal value accrual.

Goal value apportionment is the top down process of forced distribution of a goal's value among its directly included goals. In this step, each including goal is ignorant about whether an included goal contributes to the accomplishment of other including goals. The goal lattices of FIGS. 1A and 1B are useful for illustrating the relationship among subservient (included) and dominating (including) goals. Although these goal lattices lack quantitative information about individual goals, they show an ordering relationship between what might be called “soft” goals near the top and “hard” goals near the bottom, where “soft” goals generally refer to conceptual and strategic objectives, and “hard” goals generally refer to finite and measurable actions or more narrowly construed objectives useful for accomplishing one or more of the soft goals.

If the ordering relation indicates that each included goal contributes to each including goal, then it is straightforward to impose on the goal lattice a zero-sum (or in this case, a 1-sum) distribution of goal values from an including goal to its included goals. That is, if we assume a value of one (1) for the topmost goal, then each included goal which directly contributes to the accomplishment of that topmost goal contributes something to that value, and hence the value is distributed among the lower order goals. This is readily apparent from the simple goal lattice shown in the left half of FIG. 1A. In this goal lattice, the value of each goal is uniformly distributed among the included goals, a distribution that follows from an assumption that each directly included goal contributes equally to the including goal.

For example, the topmost goal of FIG. 1A has three (3) included goals. Assuming the topmost goal has a value of one (1), the sum of the values of its included goals will be equal to the value of the top most goal, namely, one (1). If each of the three included goals makes an equal contribution to the topmost included goals on equal value based on its relative contribution, each of the three (3) included goals would have a contribution of 0.33 to that value. Similarly, of the three (3) goals that are subservient and thus included in the topmost goal, the left most goal is a dominant and including goal having two (2) subservient or included goals. Thus, the value of the left most goal is distributed among each of the two included goals, resulting in a distribution of one half (½) its value (e.g., 0.5.×.0.33=0.167) to each assuming equal contributions therefrom.

Uniform apportionment of values among included goals, as shown in FIG. 1A, is the exception rather than the norm. It is more likely that some included goals are more necessary to accomplish the including goal than others, resulting in higher relative value apportionment for those included goals. An example of this is shown in the goal lattice of the FIG. 1B, in which the values of including goals are not equally distributed among the included goals.

In addition, the values of some included goals receive contributions from more than one including goal. For instance, among the goals on level C of the goal lattice structure shown by FIG. 1A, the value of the left most goal receives contributions from the left most and central goal of level B. Therefore, assuming equal apportionment of values from the including levels to included levels, the value of 0.28 represents a contribution of 0.167 from the left most goal and 0.11 from the central goal of level B. The process of associating values from plural including goals to a single included goal is the second part of step 203, generally referred to as goal value accrual, which will be described hereinafter.

Generally, a goal contributes to the accomplishment of more than one including goal and as such, should receive value based on its contribution to each of those including goals, even if it is only included in a single including goal. Once the goal values are apportioned among included goals, it is simple to perform goal value accrual by summing the contribution each goal makes to the goals which are included in it. Through this process, each included goal in the goal lattice acquires its value which is then apportioned among its included goals. FIGS. 1A and 1B show value accrual as well as value apportionment.

The process of generating a goal lattice can therefore comprise steps of identifying all relevant goals; ordering the goals in a goal lattice, and for each layer in the goal lattice, apportioning each goal's value among directly included goals and accruing values at each included goal.

Computationally this is a remarkably simple procedure once the off-line task of identifying goals and ordering them has been accomplished. The simplicity of the computation allows for real-time updating of the goal lattice, and hence the values of particular action items, thus changing their relative importance in direct relationship to their contribution to the accomplishment of the goals.

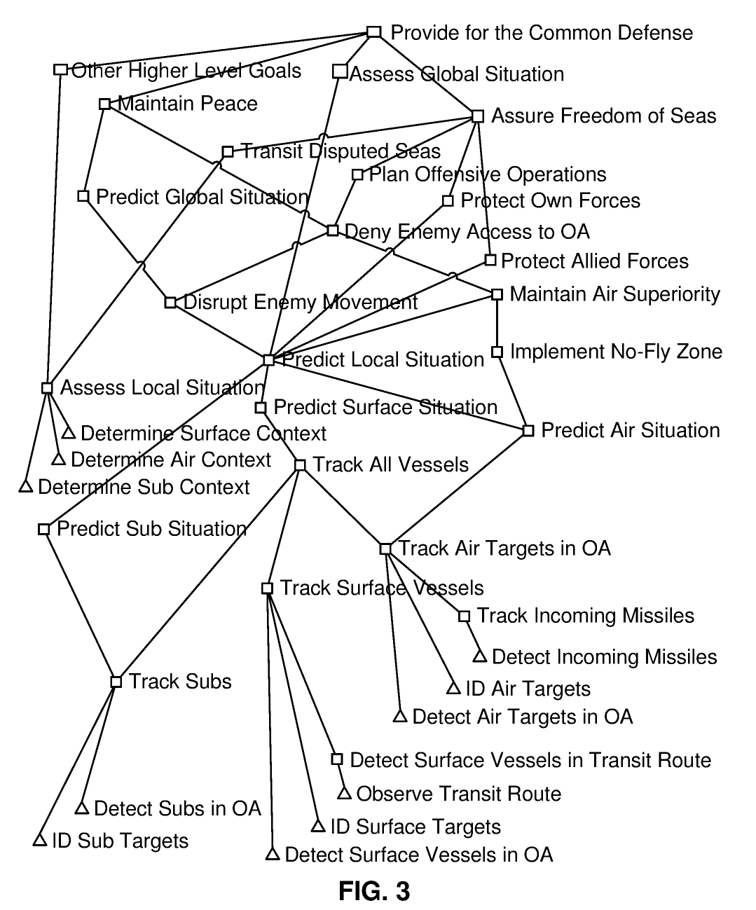

FIG. 3 illustrates an example of a particular goal lattice structure used to describe one implementation of the present invention.

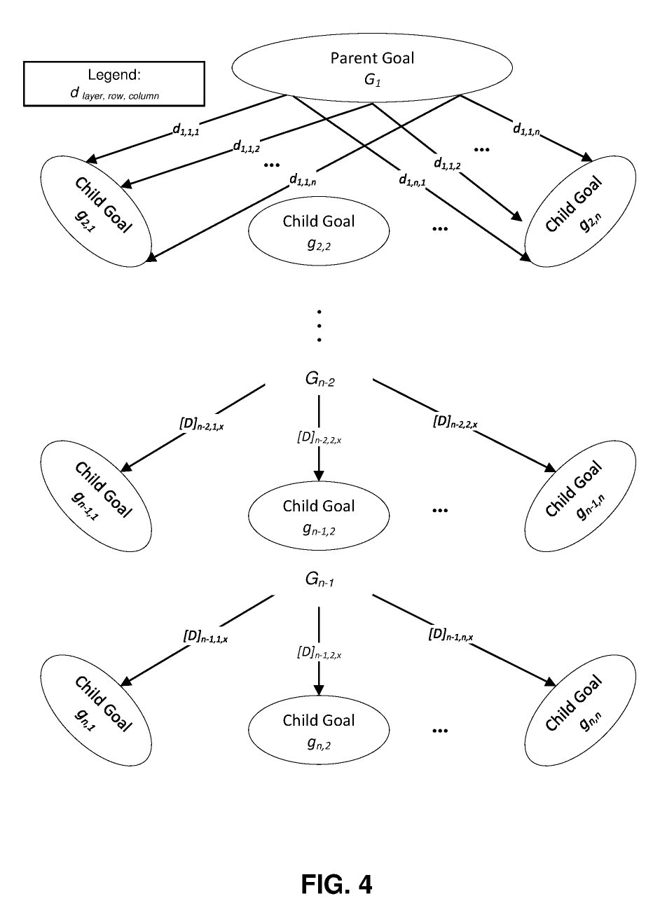

A sketch of the mathematical operations to follow is shown in FIG. 4 in which the operation of goal value apportionment and goal value accrual is formally defined as a matrix multiplication where Gᵢ is the row vector of goals at level i and Dᵢ is the distribution matrix of multiplicative coefficients from parent (level i) to child (level i+1). For example, the index i=1 distributes goal values from the parent goal layer 1 to child goal layer 2 with propagation of goal values from one layer to the next by straightforward matrix multiplication as shown below.

$${G}_{i}^{T} = [ {D}_{i - 1} ] {G}_{i - 1}^{T}$$

$${G}_{i} = [ \begin{matrix}{g}_{i , 1} & {g}_{i , 2} & … & {g}_{i , n} ]\end{matrix} \\ {D}_{i - 1} = [ \begin{matrix}{d}_{i - 1 , 1 , 1} & {d}_{i - 1 , 1 , 2} & … & {d}_{i - 1 , 1 , n} \\ {d}_{i - 1 , 2 , 1} & {d}_{i - 1 , 2 , 2} & … & {d}_{i - 1 , 2 , n} \\ ⋮ & ⋮ & ⋱ & ⋮ \\ {d}_{i - 1 , n , 1} & {d}_{i - 1 , n , 2} & … & {d}_{i - 1 , n , n}\end{matrix} ]$$

Since this is a recursion relation, bottommost goal values can be computed as a result of multiple matrix multiplications much like a sequence of linear transformations. This is delineated in the decomposition of goal layer calculations in the equation shown below which shows that the recomputation of bottommost goal values based on relative changes in topmost mission goal values during a mission, i.e., the mission value of actionable goals, can be computed by a single matrix multiply making it computationally very fast.

Gᵢ^{T}=[Dᵢ₋₁]Gᵢ₋₁^{T}

Gᵢ^{T}=[Dᵢ₋₁][Dᵢ₋₂]Gᵢ₋₂^{T}

Gᵢ^{T}=[Dᵢ₋₁][Dᵢ₋₂][Dᵢ₋₃]Gᵢ₋₃^{T}

Gᵢ^{T}=[Dᵢ₋₁][Dᵢ₋₂][Dᵢ₋₃] . . . G₁^{T}
where
G₁=[1 0 . . . 0ₙ]

A benefit of the goal lattice approach is that it allows one to quantify and make measurable amorphous, non-measurable, “soft” goals. It not only allows for the straightforward apportionment of goal values from soft goals to specific action items, but forces the system designer to formally describe the goals of the system, as well as to quantify the interrelationship among system goals. Rather than defining the system in terms of how it behaves against specific environmental scenarios, or engineering performance measures which are indirect measures of the accomplishment of system goals, the system can now be designed in terms of goal accomplishment.

Goal lattices allow for prior planning and goal value determination before a mission begins while still allowing the operator to modify the relative values of particular goals in real time. This approach of goal management rather than sensor management indirectly controls the behavior of the system rather than directly controlling the actions of specific sensors or systems. Since this is a goal directed system, if the goals have been enumerated correctly and their interrelationship properly specified, no system can perform better, because goal achievement is the performance measure.

Goal lattices should be viewed in the context of other performance measures which have been used to the optimization of sensor management systems. System management can be defined as “ . . . the process which seeks to manage or coordinate the use of sensing resources in a manner that improves the process of data fusion and ultimate perception, synergistically.” Sensor management can be contrasted with sensor scheduling, which refers to the actual allocation of measurement tasks to specific sensors. The concepts of this invention can be applied to achieve a mathematically rigorous, yet tractable and implementable approach to real-time sensor management that lends itself to piece wise optimization and evolutionary improvement. Typical conventional performance measures are chosen based solely on the ability of a well-known optimization method to optimize the achievement of mission goals. One reason the goal lattice is superior to these conventional systems is because it directly, rather than indirectly, implements strategic and tactical goals to generate a measure that can be used by the system for optimization.

When applied to sensor management and scheduling, this invention is directly and immediately applicable to several aspects of hyperspectral sensor imaging, which applications range from system analysis to system design, as well as real-time implementation of a goal-driven, almost-optimal sensor management system.

Specifically, as described above, at the system level, goal lattices require the formulation of a set of goals which the system is to accomplish. Through a straightforward procedure, an ordering relationship is used to generate a goal lattice which represents the partially ordered set (POSET) of goals. Superimposed on this goal lattice is a subjective evaluation by the system designers of the relative contribution of each included goal to the accomplishment of a higher goal. Since each lower goal contributes to several higher goals, each lower goal's value is the summation of its contributions to higher goals. The lowest goals in this goal lattice may be real and measurable actions. For instance, the lowest goals may represent sensor tasks associated with particular sensors, not necessarily homogeneous or on the same platform. The net result is that goal lattices can be used to determine how much each sensor task contributes to the accomplishment of system goals, thereby allowing a natural way of distributing funding among the development of various sensor components and a determination of the cost/benefit of new technologies directly in terms of R&D costs and goal accomplishment.

Tradeoff studies can also be done with this approach based on changing the relative values of different included goals as they support the overall system goal. As an example of this approach, a goal lattice has been developed for a maritime domain situation awareness and is shown in FIG. 3. This goal lattice is an example of an extension of the goal lattice concept from sensor management to mission management and the allocation of mission values to various goals. The concepts of this invention are also useful for partitioning an entire system into major components whose tasks are clearly identified and interface specified. An automatic control system model may be developed which can be used to analyze bandwidth and stability, two parameters which determine how a system responds to a stressing environment.

Concentrating use of goal lattices within the context of a real-time sensor management system results in still other advantages. The use of goal lattice values to determine the relative values of specific sensor actions in terms of how they contribute to goals allows for a partitioning and subsequent independent optimization of the sensor scheduling task from the sensor management task. That is, direct control is done through an automatic control loop which deals with the relative value or importance of goals and information collection to support those goals with indirect control being given to the human operator through the ability to modify the values associated with individual goals in real time.

The concept of goal lattices is a concept which allows the sponsors to have significant indirect effect on the allocation of R&D resources since it allows managers of a system (e.g., responsible military officers) to either prepare the system goal lattice and assign relative values to the included goals or to evaluate the goal lattice prepared by the contractor and alter the relative values or add additional goals. The relative values of specific actions or funding of particular programs are then calculated dispassionately by the goal lattice based on the ability of that R&D effort to contribute to mission goals. An example of this is shown in FIG. 4.

If a new R&D program is proposed, it can quickly be evaluated relative to other existing programs by determining how it contributes to the goal lattice of system goals. With this approach, some of the goal accomplishment that had been apportioned to other programs must be diverted to this new program. The new program may acquire a small amount of this goal value or a lot, depending on how well it contributes to the accomplishment of the goals relative to the other programs. The new values assigned to existing programs and the newly proposed programs can be used to either make linear funding decisions in terms of a continuous medium such as dollars, or used as a binary decision to decide which programs to support or cancel based on their relative worth in terms of their support of system goats.

Another benefit of goal lattices and a method of constructing, modifying, and displaying them is the concept of d goals. Goal lattices can be used for mission management, indirect management of a large number of intelligent agents, and collaboration among those agents. While initially conceived for the management of intelligence collection agents, goal lattice use can be expanded to any agents which are able to contribute to the accomplishment of shared goals. We refer to this sharing of goals among multiple agents as implicit collaboration.

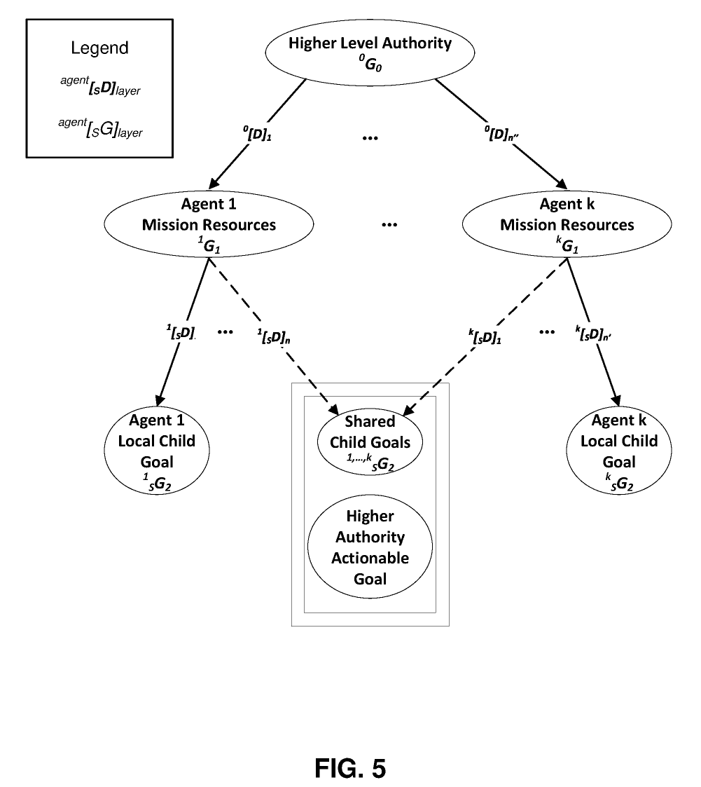

The individual actionable goals from the GL of the higher authority GL are assigned to agents in order to implement them. If this process results in an actionable goal being assigned to more than one agent as shown in FIG. 5, then there now exists a shared goal between Agent 1 and Agent k, each of which may have its own local goals which it does not share with the other. Examples of local goals are collaborate, protect self, and avoid detection.

To be consistent with the goal value computations of the earlier equation, we subdivide the goal vector of length n into a first part which is the m local (unshared) goals and a second part consisting of the n-m shared goals. This local/shared goal vector is now represented by the subscripted prefix, S, as _{S}G of the equation below

[_{S}G]ᵢ=[g_{i,1},g_{i,2} . . . g_{i,m} [symbol] s_{i,m+1} . . . s_{i,n}]

_{S}Gᵢ=[Gᵢ [symbol] Sᵢ]
where the local goals vector of length m is

Gᵢ=[g_{i,1}g_{i,2}. . . g_{i,m}]
and the shared goals vector of length n-m is

[Sᵢ=s_{i,m+1}s_{i,m+2} . . . s_{i,n}]
resulting in a goal value computation at any layer being

[_{S}G]ᵢ^{T}=[_{S}D]ᵢ₋₁[_{S}G]ᵢ₋₁^{T}
The shared/local, allocation/accrual matrix, _{S}D is comprised of the partitioned matrix,

[_{S}D]ᵢ₋₁=[ [symbol] ]ᵢ₋₁
which can be further expanded into its elements

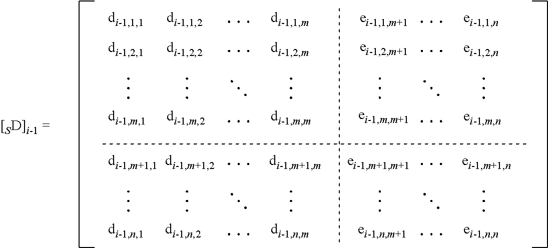

The net result is that the goal computation for the local and shared goals can be computed as a partitioned matrix multiply

[_{S}G]ᵢ^{T}=[ [symbol] ]ⁱ⁻¹[_{S}G]ᵢ₋₁^{T}
from layer to layer just as with the local goal value propagation previously shown. By extension, and noting the identical iterative nature of the GL value computation, the bottommost goal values can be calculated from the time varying topmost values through a single matrix multiply,

[_{S}G_{bottom}]^{T}=[_{S}D_{composite}][_{S}Gₜₒₚ]^{T}
again, making for a simple, computationally fast allocation of mission goal values from the top, through the lattice, down to the real, measurable action items.

Although the concept of goal lattices is presented within the context of a sensor management system, it is equally applicable to any system in which there are multiple competing or contributing goals and multiple competing means of accomplishing those goals. For example, it is also possible for one to use the technique to attempt to model the goal lattice of an opponent by measuring his actions and inferring the values which he has placed on his intermediate goals. The better assessment there is of an opponent's goals, the better one can deploy one's own resources to counter the threat.

While there have been illustrated and described here what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

A displayed goal lattice is an instantiation of a goal lattice which is typically stored in a relational database in a digital memory and whose structure and values are transformed into a representation which can be viewed by a human observer.

A goal lattice element is a goal identifier, a goal value, a directed connection between two goals, a value associated with a directed connection between two goals or the like. Mathematical computations or operations that can be performed on the mathematical representation of a goal lattice are referred to as goal lattice operations. Examples of the types of mathematical operations include but are not limited to modifying the value associated with an input edge; modifying the value associated with an output edge; deleting an input edge; adding an input edge; deleting an output edge; adding an output edge and specifying its destination goal; inserting a goal; and the like.

A goal lattice operation parameter is a numerical or string value associated with a goal lattice element. It can be a range of values or a set of fixed values and may be symbolic or human understandable.

A kinematic state input device can be any of a number of devices that sense the inertial or kinematic state of the input device and produce position, velocity, acceleration, or other physical kinematic state values. The kinematic state input device is also capable of properly producing, formatting, and transferring the kinematic data to a subsequent processing apparatus.

While the normal usage of the apparatus or method is to have a human operator select and manipulate goal lattices, externally generated goal selection signals may be generated by an external apparatus and replace or supplement human inputs.

During normal operation, and particularly when using human input, the display of the goal lattice may use one or more methods of differentiating among the multiplicity of elements in the GL. For example, color, goal shapes, goal sizes, line widths, line style (solid, dash) or the like may be used to represent the data values associated with the elements.

Furthermore, there may be temporal variations in any or all of these parameters in order to more easily transfer information from the apparatus to the human's visual system in order to improve the level and speed of comprehension of complex data.

The apparatus is not necessarily self-contained in a single apparatus or location and there may be wired or wireless connections among the various components or external apparatus. In particular, input devices may be connected wirelessly to improve usability.

While we focus here on the volumetric display (3D), input and output methods employing tactile or other human sensible means may also be used. For example, a physically impaired person may use tactile sensors or pressure sensors or vibratory sensors with which to adjust the relative values of the goals associated with the operation of a prosthetic device.

Another aspect of dynamic goal lattices which does not relate simply to their variation over time and the display of that variation is the concept of dynamic goals themselves. These dynamic goals are transient goals which are instantiated “on the fly” during the operation of a sensor management system. In that regard the dynamic goal may be to track an incoming missile, a goal for which may not present until there is a missile being tracked. Tracking that incoming missile provides for the common defense, but requires radar time, etc. If dynamic goals are looked at from the point of view of electrical power systems, an example would be for an industrial plant to establish communications and notify the utility provider that they will be turning on a 100 MW motor requiring 10 times the normal amount of current for startup. Dealing with the value of this additional goal could be instantiated as a transient, or dynamic goal in the goal lattice. The goal lattice construction apparatus and method can incorporate in its operation the differentiation between global, or constant structure goals and transient, or dynamic goals which come and go.

1. A method comprising:
a) obtaining at least one system goal lattice from an automatic control system;
b) displaying the at least one system goal lattice on a visualization device;
c) selecting at least one first goal lattice element from the at least one system goal lattice employing at least one input device;
d) choosing at least one goal lattice element operation employing at least one of the at least one input device;
e) receiving at least one goal lattice element operation parameter utilizing at least one of the at least one input device;
f) producing a modified system goal lattice by applying the at least one goal lattice element operation and the at least one goal lattice element operation parameter to the at least one first goal lattice element; and,
g) communicating the modified system goal lattice to the automatic control system.

2. A method of claim 1, wherein the displaying of the at least one system goal lattice is a multidimensional representation of the at least one system goal lattice.

3. A method of claim 1, wherein the displaying of the at least one system goal lattice utilizes a multiplicity of colors to visually differentiate among different elements.

4. A method of claim 1, wherein the displaying of the at least one system goal lattice is produced utilizing a mathematical projection of the at least one system goal lattice from a multidimensional space onto at least one rotatable, scalable, editable representation in a two-dimensional space.

5. A method of claim 1, wherein the displaying of the at least one system goal lattice is dynamic.

6. A method of claim 1, wherein the at least one input device is an automatic control system.

7. A method of claim 1, wherein the at least one goal lattice element operation comprises at least one of the following:
a) modifying the value associated with an input edge;
b) modifying the value associated with an output edge;
c) deleting an input edge;
d) adding an input edge;
e) deleting an output edge;
f) adding an output edge and specifying its destination goal;
g) inserting a goal;
h) extracting partial goal lattices;
i) inserting a partial goal lattice; and,
j) inserting transient goals.

8. A method of claim 1, wherein the choosing of the at least one goal lattice element operation comprises actuating the at least one input device, producing a menu of available at least one goal lattice element operation from which to choose.

9. A method of claim 1 wherein
a) the selecting of at least one goal lattice element operation is in accordance with an externally generated goal lattice element operation selection signal; and,
b) the receiving of at least one goal lattice element operation parameter is in accordance with an externally generated at least one goal lattice element operation parameter from the automatic control device.

10. An apparatus comprising:
a) a system goal lattice reception device configured to receive at least one system goal lattice;
b) a system goal lattice visualization device capable of displaying the at least one system goal lattice;
c) a system goal lattice element selection device wherein the system goal lattice element selection device selects at least one system goal lattice element from the at least one system goal lattice;
d) a system goal lattice element operation selection device wherein the system goal lattice element operation selection device selects at least one goal lattice element operation;
e) a system goal lattice element operation parameter selection device wherein the system goal lattice element operation parameter selection device selects the at least one system goal lattice element operation parameter;
f) a system goal lattice modification processor configured to produce a modified system goal lattice by applying the at least one system goal lattice element operation and the at least one system goal lattice element operation parameter to the at least one selected system goal lattice element; and,
g) outputting the modified system goal lattice to an automatic control system.

11. An apparatus of claim 10 wherein the system goal lattice element selection device comprises at least one of the following:
a) a haptic device;
b) a touchscreen;
c) a mouse;
d) a trackpad;
e) a trackball;
f) an audio input;
g) an automatic control system, and,
h) a kinematic state input device

12. An apparatus of claim 10 wherein the system goal lattice element selection device is wirelessly connected.

13. An apparatus of claim 10 wherein the system goal lattice visualization device is a heads-up display.

14. An apparatus of claim 10 wherein the goal lattice visualization device utilizes at least two visual effects to differentiate among goal lattice elements.

15. An apparatus of claim 10 wherein the at least two visual effects comprise at least one of the following:
a) line thickness;
b) line color;
c) goal shape;
d) line intensity;
e) line style; and,
f) temporal variations.

16. An apparatus of claim 10 wherein the system goal lattice visualization device utilizes the visual effects to differentiate between goal lattices of collaborating automatic control devices.

17. An apparatus of claim 10, wherein the at least one system goal lattice element operation comprises at least one of the following:
a) modifying the value associated with an input edge;
b) modifying the value associated with an output edge;
c) deleting an input edge;
d) adding an input edge;
e) deleting an output edge;
f) adding an output edge;
g) inserting a goal;
h) extracting partial goal lattices;
i) inserting a partial goal lattice; and,
j) inserting transient goals.

18. An apparatus comprising:
a) a system goal lattice reception device configured to receive a system goal lattice from an automatic control system;
b) a system goal lattice visualization device;
c) at least one input device generating at least one system goal lattice visualization control signal;
d) a system goal lattice modification processor configured to modify the system goal lattice in accordance with the at least one system goal lattice visualization control signal to produce a modified system goal lattice; and,
e) a modified system goal lattice display device.

19. An apparatus of claim 18, wherein the at least one system goal lattice visualization control signal comprises at least one of the following:
a) zoom in;
b) zoom out;
c) warp;
d) transform;
e) fit;
f) translate; and,
g) rotate.

20. An apparatus of claim 18, wherein the system goal lattice modification processor comprises a graphics processing unit.
